(19) United States
(12) Patent Application Publication
(10) Pub. No.: US 2024/0354656 A1
(43) Pub. Date: Oct. 24, 2024

(54) A Method of Re-Baselining a Plurality of AI Models and a Control System thereof

(71) Applicant: Robert Bosch GmbH, Stuttgart (DE)

(72) Inventor: Manojkumar Somabhai Parmar, Ahmedabad (IN)

(21) Appl. No.: 18/681,451

(22) PCT Filed: Aug. 1, 2022
(86) PCT No.: PCT/EP2022/071574

§ 371 Date: Feb. 5, 2024

(30) Foreign Application Priority Data
Aug. 9, 2021 (IN) 202141038598

(51) Int. Cl. G06N 20/00

(52) U.S. Cl. CPC G06N 20/00

(57) ABSTRACT

A method is for re-baselining a plurality of AI models residing in a plurality of independent edge devices. The AI models self-learn in the edge devices and are extracted from the edge devices to a version-controlled database. This is followed by diagnoses of the learnings of the self-learnt AI models on a digital twin environment of the edge device. A group of self-learnt AI models with good learnings are selected based on the diagnosis. Next these groups of selected AI models are subjected to federated learning to get a re-baselined model. The re-baselined model is validated using the digital twin and is pushed into the plurality of edge devices using firmware over the air.

### FIELD OF THE INVENTION

The present disclosure relates to a method of re-baselining a plurality of AI models and a control system adapted for re-baselining the plurality of AI models.

### BACKGROUND OF THE INVENTION

In its nascent phase, Artificial intelligence (AI) has been deployed in the cloud as AI algorithms process massive amounts of data and consume massive computing resources. But as AI technology has progressed many of its applications require AI-based data crunching and decisions need to be made locally, on devices that are close to the edge of the network. Hence AI systems are migrating towards the edge from the cloud today. AI in the edge devices allows critical and time-sensitive decisions to be made faster, more reliably and with greater security despite of unstable network connectivity. The need to push AI to the edge is also being fueled by the rapid growth of edge devices such as smartphones, smart wearables and sensors monitoring machines and infrastructure. Hence, learnings are shifting from a centralized lab or a cloud to real-life situations on edge devices. This natural evolution is causing devices to self-learn in the field.

Although this AI technology evolution is making latency low and processing faster, we are witnessing issues in self-learning. The systems that learn from their environment in the field do not have a mechanism to differentiate appropriate learning from inappropriate learning (anomalous learning). The AI does not have its own consciousness to differentiate the good learning from bad. One such well-known example was the case of Microsoft chatbot which started abusing people. Therefore, there is a need to check the quality of learning and take appropriate actions. Failure to do can also result in product liability when products are making decisions that are not helpful for end-users and society. Therefore, there is a need to govern AI learning on the edge devices.

Patent application US20170048308A1 titled “System and Apparatus for Network Conscious Edge to Cloud Sensing, Analytics, Actuation and Virtualization” discloses a method and apparatus for network conscious edge-to-cloud data aggregation, connectivity, analytics and actuation operate for the detection and actuation of events based on sensed data, with the assistance of edge computing software-defined fog engine with interconnect with other network elements via programmable internet exchange points to ensure end-to-end virtualization with cloud data centers and hence, resource reservations for guaranteed quality of service in event detection.

### BRIEF DESCRIPTION OF THE ACCOMPANYING DRAWINGS

An embodiment of the invention is described with reference to the following accompanying drawings:

FIG. 1 depicts a control system deployed for re-baselining a plurality of AI models residing in a plurality of independent edge devices (102);

FIG. 2 illustrates method steps for re-baselining a plurality of AI models.

### DETAILED DESCRIPTION OF THE DRAWINGS

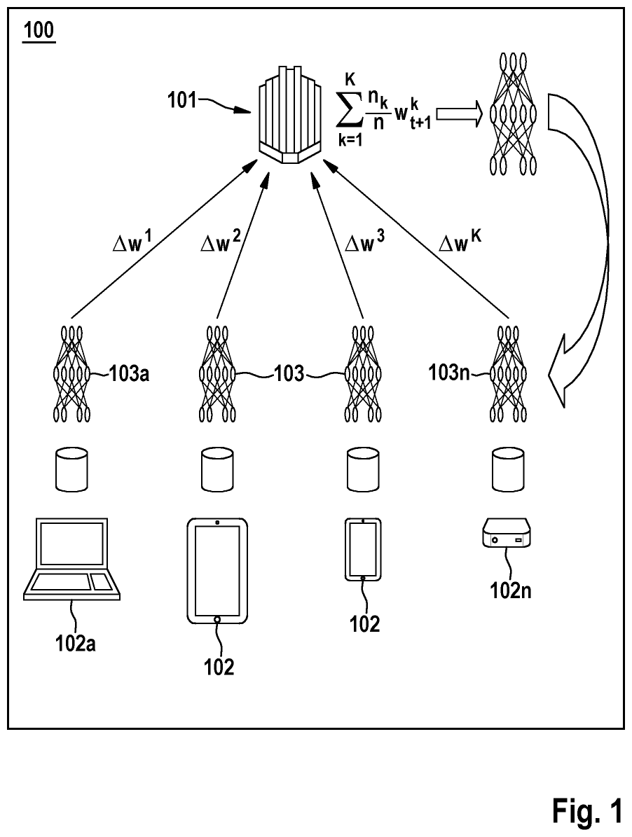

FIG. 1 depicts a control system (101) deployed for re-baselining a plurality of AI models (103) residing in a plurality of independent edge devices (102). The control system (101) comprises a processor, a memory and at least a network interface. The processor can either be a logic circuitry or a software programs that respond to and processes logical instructions to get a meaningful result. A hardware processor may be implemented in the system as one or more microprocessors, microcomputers, microcontrollers, digital signal processors, central processing units, state machines, logic circuitries, and/or any component that operates on signals based on operational instructions.

The plurality of independent edge devices (102) are connected to the network interface. The network interface is defined as a software or hardware interface between two pieces of equipment or protocol layers in a computer network. With reference to this disclosure the network interface acts as a bridge between the plurality of independent devices and the processor of the control system (101). An edge device is defined as any component responsible for connecting with a network. In simple terms an edge device can be anything (102a to 102n) from a smartphone, laptop to a router which connects to the internet.

The plurality of AI models (103) reside in the plurality of independent edge devices (102). An AI model with reference to this disclosure can be defined as reference or an inference set of data, which is use different forms of correlation matrices. Using these models and the data from these models, correlations can be established between different types of data to arrive at some logical understanding of the data. A person skilled in the art would be aware of the different types of AI models such as linear regression, naïve bayes classifier, support vector machine, neural networks and the like. A person skilled in the art will also appreciate that the AI models may be implemented as a set of software instructions, combination of software and hardware or any combination of the same.

Typically, the AI models used in these edge devices are involved in speech recognition, natural language processing, audio recognition, autonomous driving, etc. where they process data to generate required output based on certain rules/intelligence acquired through training. To process the inputs and give a desired output, the AI systems use various models/algorithms which are trained using the training data. Once the AI system is trained using the training data, the AI systems are deployed along with self learning mechanism. The deployed AI systems use the self learning mechanism within AI models to analyze the real time data and generate appropriate result. In this process they self-learn on the real time data.

In accordance with the present disclosure each of the plurality of the plurality of edge devices run a specified version of the AI model (103). The network interface is configured to extract theses self-learned AI models from the edge devices to a version-controlled database stored in memory of the control system (101). The version-controlled database is a form of storage where each self-learned model is stored along with its metadata like device id, model id, device type, model pulled time stamp and other relevant parameters.

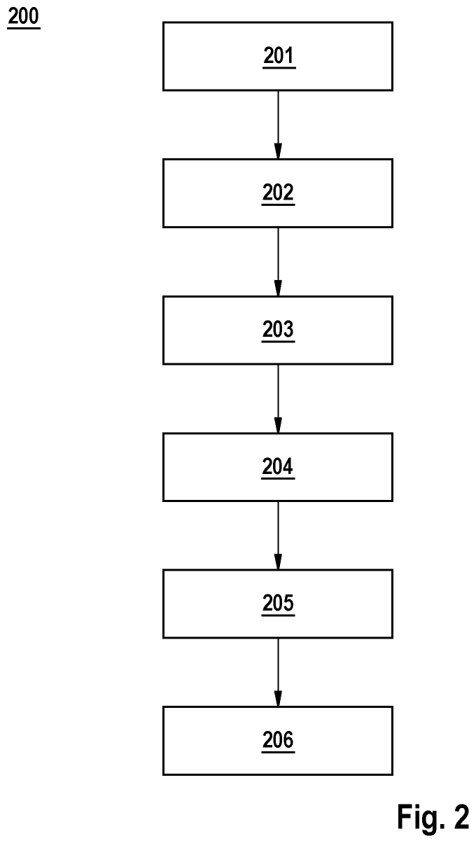

The processor disclosed in accordance with this disclosure is configured to diagnose the learnings of the self-learnt AI models on a digital twin environment of the edge device; select a group of self-learnt AI models based on said diagnosis; perform federated learning on the selected group of AI models to get a re-baselined model; push the re-baselined model into the plurality of edge device through the network interface. This is explained by virtue of the method steps for re-baselining a plurality of AI models in accordance with FIG. 2.

FIG. 2 illustrates method steps for re-baselining a plurality of AI models. The method is performed in accordance with the system architecture explained in FIG. 1. The plurality of AI models (103) reside in a plurality of independent edge devices (102) that are connected to the control system (101) by a network interface. These AI models adapted to self-learn in the edge devices based on the real-time data. In method step 201, the network interface extracts the self-learned AI models from the edge devices to a version-controlled database at regular interval or on a need basis depending on configuration. A version controlled database stored in the memory of the control system (101) and is basically a form of storage where each self-learned model is stored along with its metadata like device id, model id, device type, model pulled time stamp and other relevant parameters.

In method step 202, the processor diagnoses the learnings of the self-learnt AI models on a digital twin environment of the edge device. The digital twin environment mimics the real-time physical objects, their interactions and processes going inside the physical world. It acts as a virtual representation of a physical environment or process that allows analysis of data and monitoring of systems to predict the self learn models performance characteristics in physical world. In this case the physical environment are the plurality of independent edge devices (102) and the context in which run their respective AI models. For example, the plurality of AI models in one scenario could be the version of AI models that is responsible for assisting the user in predictive key board typing. In another scenario wherein the plurality independent devices comprise the electronic control units of a plurality of independent vehicles, the plurality of AI models in one scenario could be the version of AI models that is responsible for driver assistance and autonomous braking.

The diagnosis of learnings is done by testing the performance of the self-learnt AI models on critical tasks. During diagnosis of the plurality of self-learnt plurality, the models are fed with a spectrum of all possible inputs including critical situations corresponding to the version and the digital twin environment of the AI model. The outputs received are then analyzed to segregate the appropriate and inappropriate learnings in the plurality of self-learnt AI models. In an embodiment of the present disclosure, if a model fails on critical tasks then the model is labeled as harmful and an alert is triggered to remove the new learning from the respective edge device resulting in to baseline model with appropriate learnings.

In method step 203, the processor selects a group of self-learnt AI models based on said diagnosis. The models which performed well on critical situations and are deemed to have good learnings are categorized as a group and selected. In method step 204, the federated learning is performed on the selected group of AI models to get a re-baselined model. Federated Learning enables the group of selected AI models to collaboratively learn a shared model (re-baselined model) while keeping all the training data on the edge device, thereby decoupling the ability to do machine learning from the need to store the data in the cloud. Federated learning enables building a common re-baselined and robust machine learning model that encompasses all the good learnings to address critical issues.

In method step 205, the re-baselined model is validated using the digital twin. Once validation is complete the re-baselined model is ready to be sent to the plurality of independent edge devices (102) to replace the earlier versions of the self-leant AI models. This process of model collection, diagnosis and re-baselining is done at regular intervals (time-based) or critical events. In method step 206 the processor pushes the re-baselined model into the plurality of edge device using firmware over the air. Before the models are pushed backed using Firmware over the air (FOTA), they also go through hardware specific model optimization and software specific model optimization. Hardware specific model optimization is the fine tuning of the AI model done in accordance with the hardware specific requirements of the edge device such as generalized hardware optimization and multiple target hardware optimization.

This idea to develop a method of re-baselining a plurality of AI models and a control system (101) thereof basically ensures that models which are self-learning in the field (edge AI) are brought back and re-baselined. This regulates the quality of learning in the field/edge devices ensuring accountability for the product manufactures. It must be understood that the disclosure in particular discloses methodology used to re-baseline a plurality of AI models residing in a plurality of independent edge devices (102). While these methodologies (200) describes only a series of steps to accomplish the objectives, these methodologies are implemented in the control system (101) (100), which may be modified according to the requirements.

It must be understood that the embodiments explained in the above detailed description are only illustrative and do not limit the scope of this invention. Any modification to the method of re-baselining a plurality of AI models and a control system (101) thereof are envisaged and form a part of this invention. The scope of this invention is limited only by the claims.

1. A method of re-baselining a plurality of AI models residing in a plurality of independent edge devices, the AI models adapted to self-learn in the edge devices, the method comprising:
extracting the self-learned AI models from the edge devices to a version controlled database;
diagnosing learnings of the extracted self-learned AI models on a digital twin environment of the corresponding edge device;
selecting a group of self-learned AI models based on said diagnosis;
performing federated learning on the selected group of AI models to get a re-baselined model;
validating the re-baselined model on said digital twin environment; and
pushing the re-baselined model into the plurality of edge devices using firmware over the air.

2. The method of claim 1, wherein each edge device of the plurality of edge devices run a specified version of the AI model.

3. The method of claim 1, wherein the diagnosis of learnings is done by testing a performance of the extracted self-learned AI models on critical tasks.

4. The method of claim 1, wherein the selection of the group of AI models is based on a performance of the AI models in critical tasks.

5. A control system for re-baselining a plurality of AI models, the control system comprising:
a processor;
a memory; and
at least one network interface,
wherein the plurality of AI models reside in a plurality of independent edge devices,
wherein the AI models are adapted to self-learn in the plurality of independent edge devices,
wherein the plurality of independent edge devices are connected to the at least one network interface,
wherein the at least one network interface is configured to extract the self-learned AI models from the edge devices to a version controlled database stored in the memory;
wherein the processor is configured to:
diagnose the learnings of the extracted self-learned AI models on a digital twin environment of the corresponding edge device;
select a group of self-learned AI models based on said diagnosis;
perform federated learning on the selected group of AI models to get a re-baselined model;
validate the re-baselined model on said digital twin environment; and
push the re-baselined model into the plurality of edge devices through the network interface.

6. The control system as claimed in claim 5, wherein each edge device of the plurality of edge devices run a specified version of the AI model.

7. The control system as claimed in claim 5, wherein the diagnosis of learnings is done by testing a performance of the extracted self-learned AI models on critical tasks.

8. The control system as claimed in claim 5, wherein the selection of the group of AI models is based on a performance of the AI models in critical tasks.
